(19) United States
(12) Patent Application Publication
(10) Pub. No.: US 2022/0238050 A1
(43) Pub. Date: Jul. 28, 2022

(54) INFORMATION TERMINAL DEVICE

(71) Applicant: KABUSIKIGAISYA DIGIMED, Wakayama (JP)

(72) Inventor: Kaisyou Hoshibata, Wakayama (JP)

(21) Appl. No.: 17/619,230

(22) PCT Filed: Jun. 11, 2020
(86) PCT No.: PCT/JP2020/022983

§ 371 Date: Dec. 14, 2021

(30) Foreign Application Priority Data
Nov. 27, 2019 (JP) 2019-213787

(51) Int. Cl. G09F 9/30; G04G 21/00; G04G 17/08; G06F 1/16

(52) U.S. Cl. CPC G09F 9/301; G06F 1/1652; G04G 17/08; G04G 21/00

(57) ABSTRACT

An information terminal device according to the present invention is configured to be compact, and realizes high-level functionality and/or multi-functionality by drawing out a second input/output portion from the rear side of a first input/output portion, in a wristwatch type information terminal device. In addition, the first input/output portion is configured to include a plate-shaped first input/output portion body, first guide members that are provided on both sides of the first input/output portion body, as pairs, and are also provided as front and back (top and bottom) pairs, and folding members that are provided on the base end side so as to increase/decrease the distance between the first guide members. The second input/output portion is configured to include a plate-shaped second input/output portion body and second guide members that are provided on both sides thereof, as a pair.

### TECHNICAL FIELD

The present invention relates to an information terminal device, and particularly to an information terminal device that is favorably implemented in wristwatches.

### BACKGROUND ART

As semiconductor technologies have become more advanced, it has become possible for wristwatch sized devices to have various functions. An example of this is a device that can switch from displaying the time as a watch to being used as a pedometer, and may have a variety of functions with which biological information can be acquired such as heart rates, blood pressure, and blood oxygen levels. However, information that is currently acquired in such a way is difficult to manage, that is to say that the information is merely acquired and difficult to use, and is actually transferred to a smartphone to be used.

Also, as another example, there are also devices that are wristwatch sized and function as wearable terminals. For example, there are devices that include functions such as giving notifications when an email is received, and displaying small portions of email at a time. However, the capabilities of such devices are limited due to the screen, or in other words due to limitations of the size of the dial face. For example, it is difficult to read long emails and perform advanced display of information such as web browsing on such screens, and it is also difficult to perform input operations such as operating touch panels viewed on such display screens.

Therefore, in Patent Document 1, a wristwatch having an information terminal function is proposed in which the screen is folded into two when not used, and the size of the display screen can be roughly doubled by opening the folded screens when used. However, there is a problem in that, because the screen is foldable, in Patent Document 1, a hinge is present between two screens, and the screen continuity is damaged.

Therefore, the inventors of the present invention have proposed Patent Document 2 in advance. Patent Document 2 discloses a wristwatch type information terminal device in which the free end side of an input/output portion made of film is exposed in a dial face portion of a main body, the base end side is housed in the main body in a wound state, and the area of the input/output portion is enlarged by drawing out and expanding the housed portion.

### CITATION LIST

### Patent Document

### Patent Document 1: JP 2000-214277A

### Patent Document 2: JP 6564923B

### DISCLOSURE OF INVENTION

Patent Document 2 discloses a wristwatch type information terminal device that realizes high-level functionality and/or multi-functionality by increasing the area of an input/output portion, and also can make the screen continuous. However, in Patent Document 2, there remains room for improvement with respect to a support structure of an input/output portion of the film, specifically the drawn out portion. For example, in Patent Document 2, there is room for improvement regarding the support structure of the input/output portion with respect to touch operations, and also the drawing out mechanism is exposed, and there is room for improvement in terms of appearance as well.

On the other hand, in a typical known technique for increasing the area of an input/output portion by such drawing out in information terminal devices, a second input/output portion is drawn out from the rear side of a first input/output portion. In such a known technique, as a result of making the first input/output portion and the second input/output portion rigid, the influence on touch operations or the like can be eliminated. However, in such a known technique, a level difference is formed between the two input/output portions, and there still remains a problem in terms of screen continuity described above.

An object of the present invention is to provide an information terminal device in which a level difference between input/output portions can be eliminated and the appearance can be improved, in information terminal devices that can realize high-level functionality and/or multi-functionality by enlarging the area of the input/output portion while making the size compact, by drawing out a second input/output portion from the rear side of a first input/output portion.

In order to realize the objective described above, an information terminal device according to the present invention is configured such that, while the information terminal device being configured to be compact by drawing out a second input/output portion from the rear side of a first input/output portion so as to be able to increase the area of an input/output portion, in order to realize high-level functionality and/or multi-functionality, the first input/output portion is provided with first guide members that extend in a drawing out direction on both sides of the plate-shaped first input/output portion body, as a pair, and are also provided as a front and back (top and bottom) pair, folding members are provided on the base end side of the first guide members so as to connect the first guide members such that the distance therebetween can be increased and decreased, the second input/output portion is provided with second guide members, as a pair, that extend in the drawing out direction on both sides of the plate-shaped second input/output portion body that can be hidden on the rear side of the first input/output portion body, the second input/output portion body can be drawn out by the second guide members sliding between the first guide members, and the second guide members support the second input/output portion body so as to be movable (able to be pushed up) forward (upward) in a state of drawn out. Also, the first guide members and the second guide members are connected by connecting members that are provided, on both sides as a pair, on the free end side of the front and back (top and bottom) pair of first guide members, the connecting members hold the second guide members such that, when the second guide members are drawn out from between the front and back (top and bottom) pair of first guide members, the front and back (top and bottom) faces of the second guide members slide on the back and front (bottom and top) faces of the first guide members, and the connecting members come around to the base end side of the second guide members in a drawn out completion state.

Therefore, the second input/output portion is drawn out, as needed, from a state in which only the first input/output portion body can be used in a stacked state of the first input/output portion and the second input/output portion, which increases the area, and as a result, high-level functionality can be realized. Also, the second input/output portion is drawn out further from the free end of the first input/output portion as a result of sliding between the first guide member and the second guide member, in which the connecting members are utilized, and the first input/output portion body and the second input/output portion body are arranged side by side, and thereafter, as a result of the connecting members coming around to the base end side of the second guide members and the folding member folding, the front and back (top and bottom) pair of first guide members enter a stacked state in which the side faces are continuous, and furthermore, as a result of the second input/output portion body moving forward (upward) (pushing up) by the second guide members, the surface of the second input/output portion body can be made approximately flush with the surface of the first input/output portion body (level difference can be eliminated). Accordingly, an information terminal device whose appearance is improved across a housed (stacked) state to a drawn out (expanded) state.

### BRIEF DESCRIPTION OF DRAWINGS

FIG. 1 is a perspective view of a wristwatch type information terminal device according to one embodiment of the present invention, and shows a state when used as a wristwatch.

FIG. 2 is a perspective view at the time of changing from FIG. 1 to FIG. 5, or from FIG. 5 to FIG. 1.

FIG. 3 is a perspective view at the time of changing from FIG. 1 to FIG. 5, or from FIG. 5 to FIG. 1.

FIG. 4 is a perspective view at the time of changing from FIG. 1 to FIG. 5, or from FIG. 5 to FIG. 1.

FIG. 5 is a perspective view of the information terminal device in FIG. 1, and shows a state when used as an information terminal device.

FIG. 6 is an exploded perspective view of the information terminal device.

FIG. 7 is a cross-sectional view taken along a cut section line VII-VII in FIG. 6.

FIG. 8 is a cross-sectional view taken along a cut section line VIII-VIII in FIG. 6.

FIG. 9 is a cross-sectional view of FIG. 1.

FIG. 10 is a cross-sectional view of FIG. 2.

FIG. 11 is a cross-sectional view of FIG. 3.

FIG. 12 is a cross-sectional view of FIG. 4.

FIG. 13 is an exploded perspective view of a wristwatch type information terminal device according to another embodiment of the invention.

FIG. 14 is an exploded perspective view of a mechanism for angle adjustment in the information terminal device in FIG. 13.

FIG. 15 is a cross-sectional view of the information terminal device in FIG. 13.

FIG. 16 is a transparent side view of the information terminal device in FIG. 13.

FIG. 17 is an exploded perspective view of a wristwatch type information terminal device according to yet another embodiment of the invention.

### DESCRIPTION OF THE INVENTION

### First Embodiment

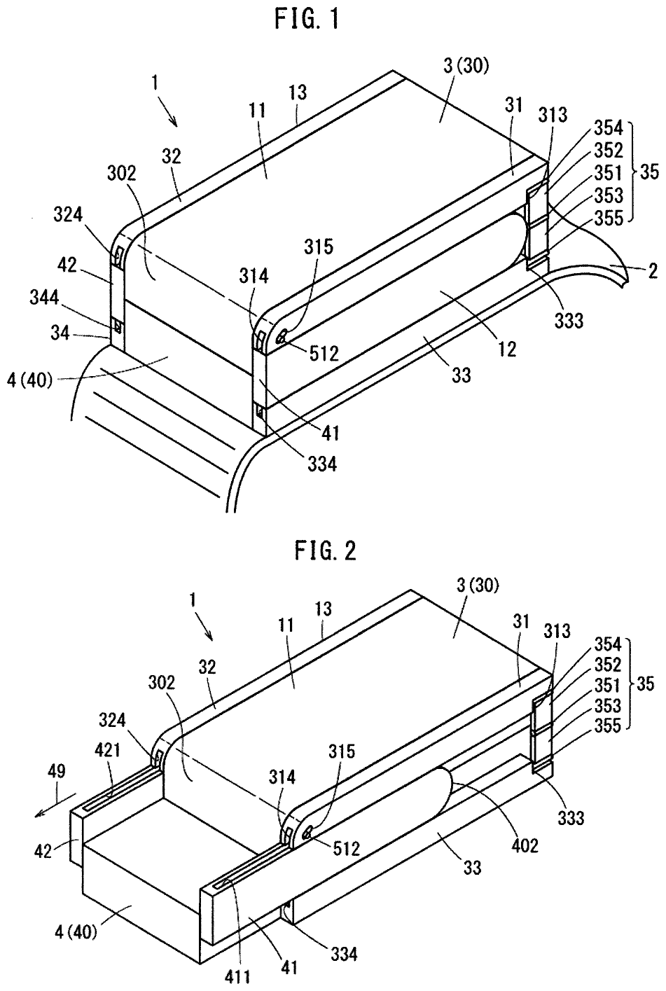

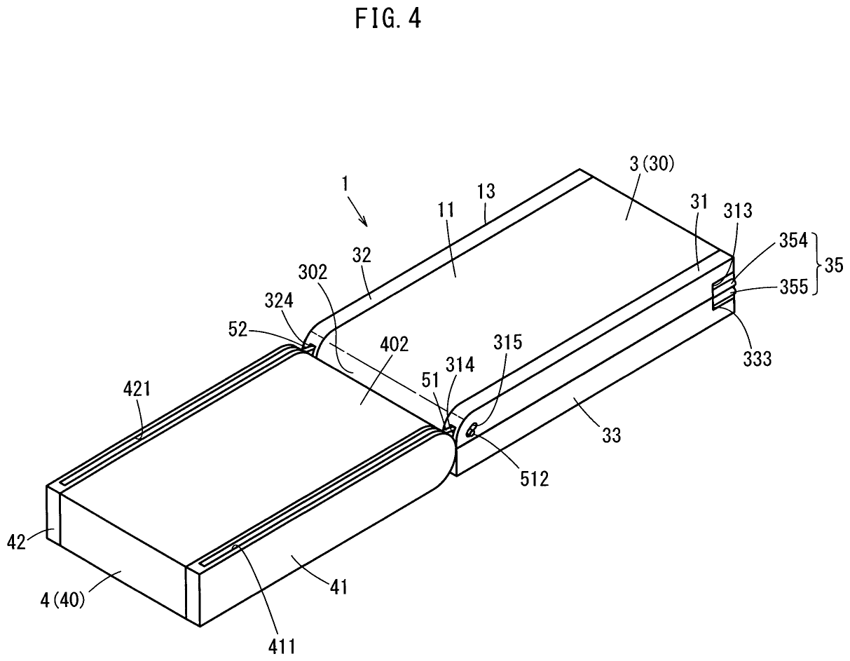

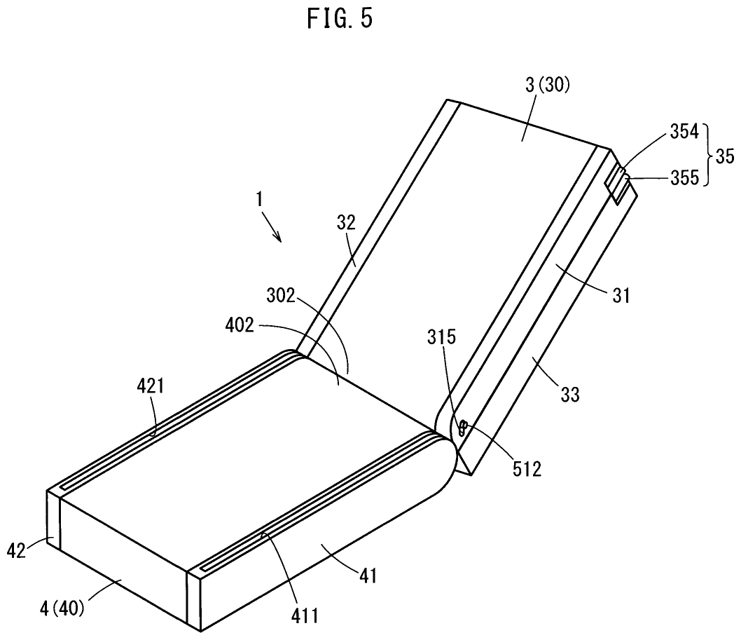

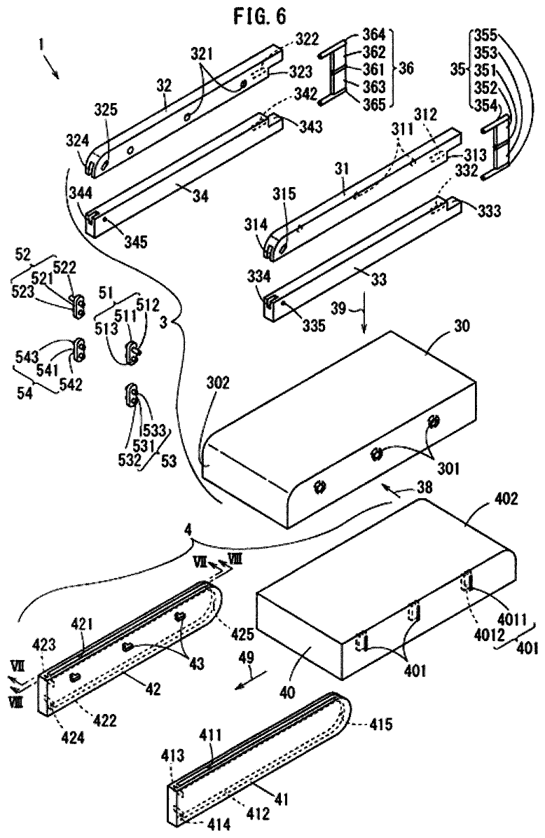

FIGS. 1 to 5 are perspective views of a wristwatch type information terminal device 1 according to one embodiment of the invention. FIG. 1 shows a state when used as a wristwatch, FIGS. 4 and 5 show a state when used as an information terminal device, and FIGS. 2 to 4 show changing states between FIG. 1 and FIG. 5. FIG. 6 is an exploded perspective view of the information terminal device 1. A wristband 2 for a wristwatch is shown in FIG. 1, and the illustration thereof is omitted in other drawings in order to simplify the drawings. A wristwatch type information terminal device 1 is illustrated in FIGS. 1 to 6, but the present invention can be implemented in mobile information terminal devices such as a game machine and a mobile phone. Note that in order to facilitate understanding of the drawings, a later-described drawing out direction, which is indicated by reference numeral 49, is described as the near side in the drawings, but in actuality, attachment is performed such that the near side of the drawings is the upward side of the wrist and the far side is the downward side of the wrist, when looking at the wristwatch.

The information terminal device 1 of the present embodiment displays the time in a dial face portion 11, when used as a wristwatch. In addition thereto, the information terminal device 1 may display, in the dial face portion 11, seconds, date, day of the week, year, and the like, as appropriate, and may also display the number of steps, blood pressure and a heart rate measured by a biosensor (not shown), or the like by changing the display mode of the information terminal device 1. Basically, switching between such display modes and the like is performed through a touch sensor or the like provided on the dial face portion 11, but may also be appropriately performed with the use of a crown, a button, or the like provided on a side portion 12, 13 or the like.

This information terminal device 1 is overall configured to include a first input/output portion 3, a second input/output portion 4, and connecting members 51, 52; 53, 54, as will be described in detail in FIG. 6. Also, in the information terminal device 1, the area of an input/output portion can be increased and all functions can be realized, for example, by drawing out the second input/output portion 4 from the rear side of the first input/output portion 3 that realizes at least some functions of display and/or input operation, as shown in FIGS. 2 to 5. In order to store (fold) and draw out (expand) the second input/output portion 4, the information terminal device 1 according to the present embodiment is configured as follows.

The first input/output portion 3 is configured to include a first input/output portion body 30, first guide members 31, 32; 33, 34, and folding members 35, 36. The first input/output portion body 30 is formed in a plate shape, an electronic paper for display or an organic EL film display with a resin substrate is attached on the surface (front face) thereof, and furthermore, a touch panel for input operation is stacked thereon. Inside the first input/output portion body 30, an information processing circuit for input and output, and a circuit for communicating with external devices, a battery, and the like are provided as appropriate.

Pairs of first guide members 31, 32; 33, 34 extending in the drawing out direction 49 are provided on both sides of the first input/output portion body 30, as front and back pairs viewed from the front, as indicated by an arrow 39 in FIG. 6. Also, folding members 35, 36 that connect the front and back pairs of first guide members 31, 32; 33, 34 so as to increase and decrease the distance therebetween are provided on the base end side in the drawing out direction 49 in the front and back pairs of first guide members 31, 32; 33, 34. Note that, when viewed from the front as indicated by an arrow 39, the first input/output portion 3 and the second input/output portion 4 are arranged in a front-back relationship, but when viewed from the side face as indicated by an arrow 38, they are arranged in a top-bottom relationship. The terms “front/back” are used throughout the following description.

A plurality of locking recessions 311, 321 (three of each in the example in FIG. 6) are respectively formed on the inner faces of the first guide members 31, 32 on the front face side, and in correspondence therewith, locking claws 301 are formed on both side faces of the first input/output portion body 30. The locking claws 301 are each formed in an umbrella or mushroom shape, and the size of each of the locking recessions 311, 321 is smaller on the entrance side than on the interior side. Therefore, when the locking claws 301 are pushed into the respective locking recessions 311, 321, the umbrellas or mushrooms open, thus functioning as retainers, and these elements are integrated. That is, the first input/output portion body 30 and the first guide members 31, 32 are fixed by fitting between the locking claws 301 and the locking recessions 311, 321, that is, by so-called snap-fitting. Conversely, the locking claws 301 may be formed in the first guide members 31, 32, and the locking recessions 311, 321 may be provided in the first input/output portion body 30.

The folding members 35, 36 are overall formed as hinges. Therefore, the folding members 35, 36 are configured such that plate shaped portions 352, 353, 362, 363 that can be opened and closed are connected on both sides of hinges 351, 361, and such that pins 354, 355; 364, 365 are formed at leading ends of the plate shaped portions 352, 353; 362, 363. Also, the pins 354, 355; 364, 365 are respectively pivotably supported by pin holes 312, 332; 322, 342 formed on the base end side of the first guide members 31, 33; 32, 34. The hinges 351, 352 are biased in a direction of folding and closing inside of the first input/output portion 3 by tension springs provided between the plate shaped portions 352, 353; 362, 363, for example. Also, notches 313, 333; 323, 343 are formed on the base end side of the first guide members 31, 33; 32, 34 for housing the folding members 35, 36.

Also, connecting members 51, 52; 53, 54 are respectively pivotably supported on free end sides of the first guide members 31, 32; 33, 34. Specifically, the connecting members 51, 52; 53, 54 are formed by providing pins 512, 513; 522, 523; 532, 533; 542, 543 in the vicinity of two end portions of connecting pieces 511, 521; 531, 541 formed by a plate or rod-shaped body (plate-shaped body in the example in FIG. 6). In correspondence therewith, slits 314, 324; 334, 344 for making the connecting pieces 511, 521; 531, 541 swingable are formed in free end side end faces of the first guide members 31, 32; 33, 34 from a sliding face side, which will be described later, in the first guide members 31, 32; 33, 34, and the pins 512, 522; 532, 542 on one side are respectively pivotably supported by pin holes 315, 325; 335, 345, inside of the slits 314, 324; 334, 344.

Meanwhile, the second input/output portion 4 is configured to include a second input/output portion body 40 and second guide members 41, 42. The second input/output portion body 40 is formed in a plate shape so as to be hidden on the rear side of the first input/output portion body 30. The second input/output portion body 40 is also formed in a plate shape, an electronic paper for display or an organic EL film display with a resin substrate is attached on the surface (front face) thereof, and furthermore, a touch panel for input operation is stacked thereon. Inside the second input/output portion body 40 as well, an information processing circuit for input and output, a circuit for communicating with external devices, a battery, and the like are provided as appropriate.

The second guide members 41, 42, which forms a pair, are respectively provided on both side of the second input/output portion body 40 and extend in the drawing out direction 49. These second guide members 41, 42 can be drawn out in the drawing out direction 49 by sliding while being sandwiched between the front and back pairs of first guide members 31, 33; 32, 34.

Also, a plurality of (three in the example in FIG. 6) sliders 43 are provided forward of the inside faces of the second guide members 41, 42, and in correspondence therewith, slide grooves 401 are formed on both sides of the second input/output portion 4. Each slider 43 is a T-shaped guide piece having a predetermined thickness when viewed in the direction of the arrow 39, and the vertical line of T passes through an opening portion 4011 of the slide groove 401 extending in the arrow 39 direction, and the horizontal bar of T is fitted into a slide groove 4012 formed inside of the opening portion 4011. In this way, as a result of the slider 43 moving inside the slide groove 401 in a state in which the second input/output portion body 40 is drawn out, the second input/output portion body 40 can be moved forward (pushed up).

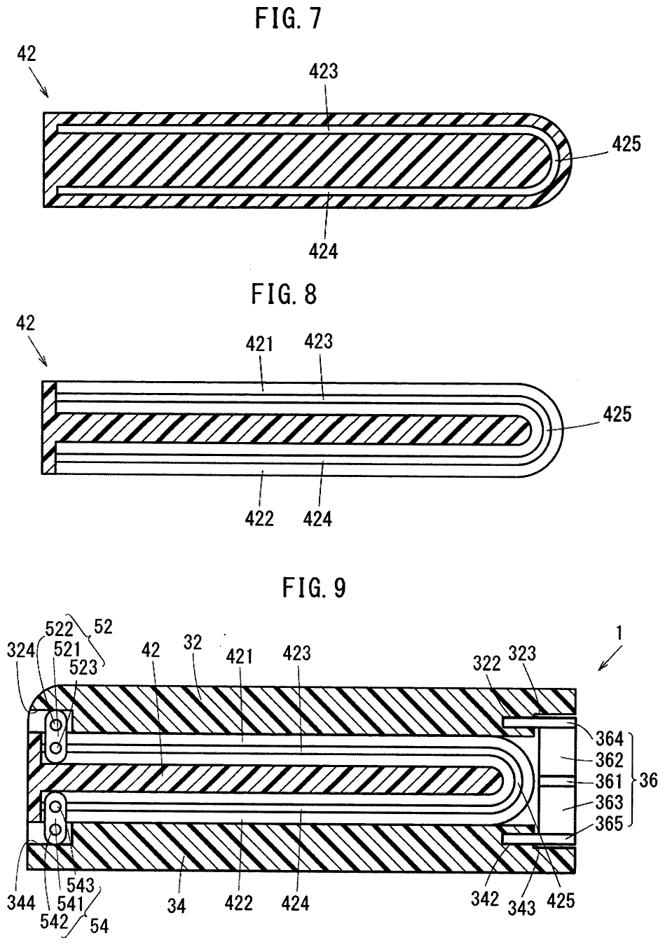

FIGS. 7 and 8 are cross-sectional views of the second guide members 42, and are cross-sectional views taken along cut section lines VII-VII and VIII-VIII, respectively, in FIG. 6. In the second guide members 41, 42, in correspondence with the connecting members 51, 53; 52, 54, slits 411, 412; 421, 422 are formed extending from a sliding face on the free end side to a base end side end face in which the connecting pieces 511, 531; 521, 541 are loosely inserted, and guide grooves 413, 414; 423, 424 that have an increased width are formed inside the slits 411, 412; 421, 422 in communication therewith. The pins 513, 533; 523, 543 slide in the guide grooves 413, 414; 423, 424. The guide grooves 413, 414; 423, 424 are formed in a semicircular arc shape on the base end side, such that the guide grooves 413, 414; 423, 424 on the front and back approach each other, and in the example in FIGS. 7 and 8, the guide grooves 413, 414; 423, 424 are connected, in each pair, in the arc-shaped portions 415, 425.

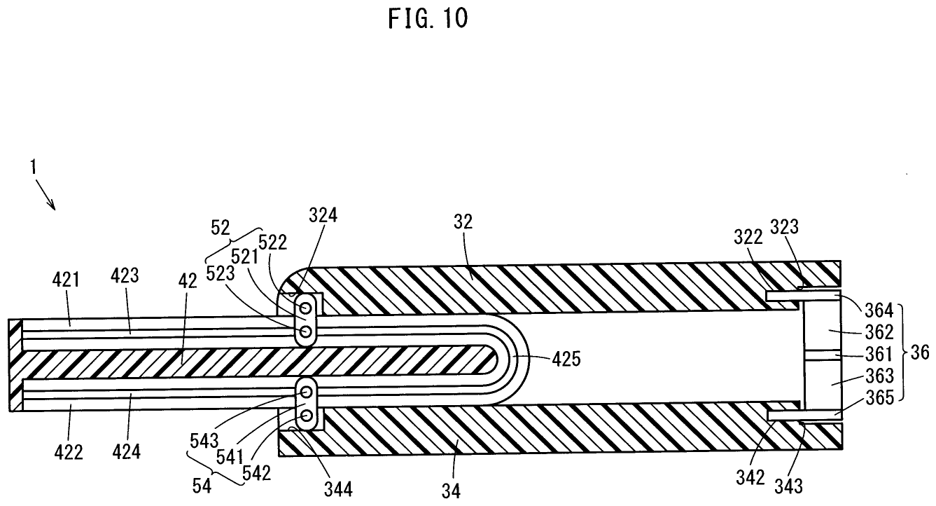

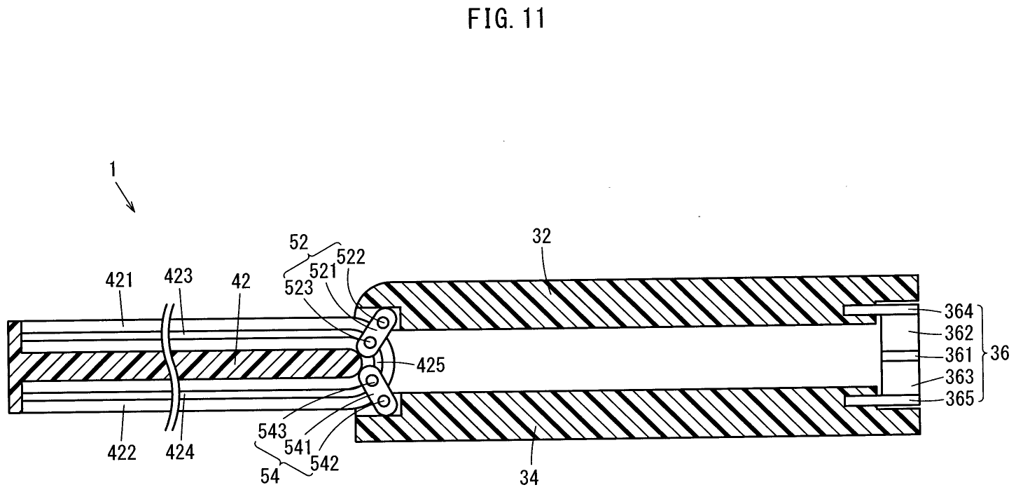

FIGS. 9, 10, 11, and 12 are cross-sectional views respectively corresponding to FIGS. 1, 2, 3, and 4. The connecting pieces 511, 521; 531, 541 of the connecting members 51, 52; 53, 54 extend upright in the direction (39) of stacking the first input/output portion 3 and the second input/output portion 4 in a state in which the second guide members 41, 42 are not drawn out as shown in FIGS. 1 and 9 and in a state of being drawn out as shown in FIGS. 2 and 10, and the front and back faces of the second guide members 41, 42 respectively hold the back and front faces of the first guide members 31, 33; 32, 34 so as to slide thereon. Therefore, the front and back faces of the second guide members 41, 42 and the back and front faces of the first guide members 31, 33; 32, 34 are the aforementioned sliding faces.

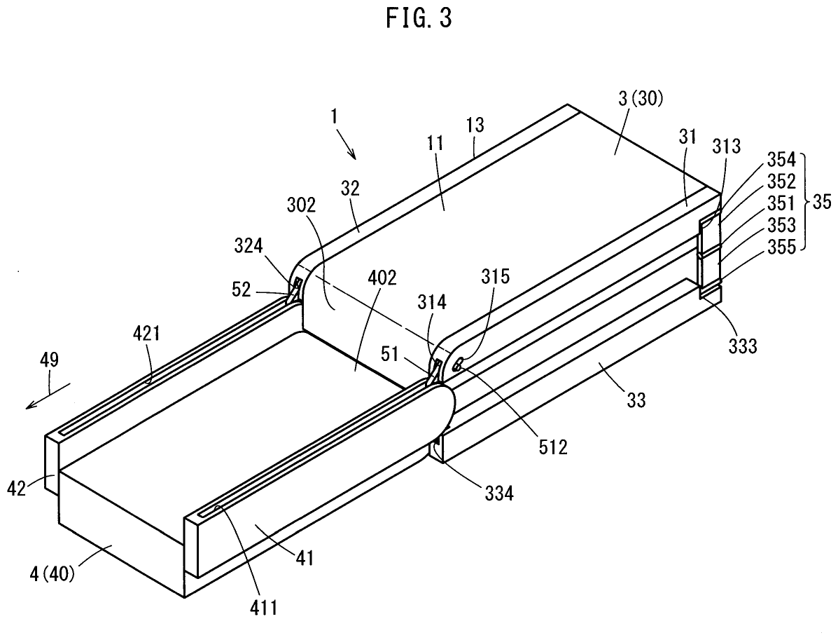

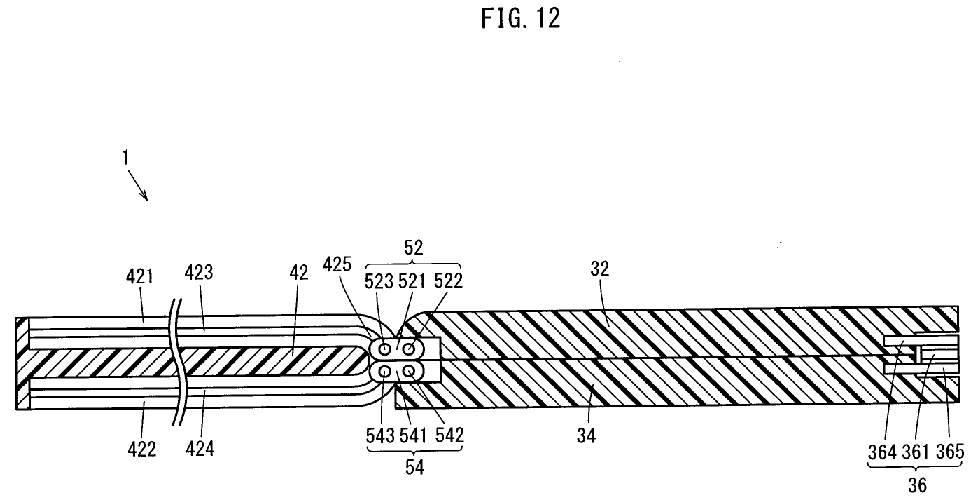

From the state immediately before drawing out completion in FIGS. 3 and 11, the pins 513, 533; 523, 543 enter the arc-shaped portions 415, 425 and fall sideways in accordance with drawing out, and as a result, the distance between the front and back pair of first guide members 31, 33; 32, 34 decreases. In a drawing out completion state in FIGS. 4 and 12, the connecting member 51, 52; 53, 54 are positioned on the base end side of the second guide members 41, 42, and the pairs of first guide members 31, 33; 32, 34 respectively come into contact. On the other hand, in accordance with drawing out of the second guide members 41, 42, the base end sides of the first guide member 31, 33; 32, 34 are caused to approach each other due to elastic force of the folding members 35, 36. In this way, when the second guide members 41, 42 fully come out from between the first guide members 31, 33; 32, 34, the folding members 35, 36 are folded, the first guide members 31, 33; 32, 34 come in close contact, and the first guide members 31, 33; 32, 34 can be arranged approximately flush with and side by side with the second guide members 41, 42.

According to such a configuration, in the mobile information terminal device 1, the first input/output portion 3 and the second input/output portion 4 can enter a state in which the second input/output portion body 40 can be used in combination, as needed, by drawing out (expanding) the second input/output portion 4 as shown in FIGS. 4 and 12 from a state in which only the first input/output portion body 30 can be used in a stacked state, shown in FIGS. 1 and 9, via the states in FIG. 2 and FIG. 10 and in FIGS. 3 and 11, and as a result, the area of the input/output portion can be increased and the high-level functionality can be realized.

Also, as shown in FIG. 4 and FIG. 12, as a result of drawing out the second input/output portion 4 further from the free end of the first input/output portion 3 while the second guide members 41, 42 slide between the first guide members 31, 33; 32, 34, which is enabled by the connecting members 51, 53; 52, 54, the first input/output portion body 30 and the second input/output portion body 40 are arranged side by side, and thereafter the connecting members 51, 53; 52, 54 come around to the base end side of the second guide members, and the folding members 35, 36 close, and as a result, the front and back pairs of first guide members 31, 33; 32, 34 enter a stacked state in which the side faces are continuous in each pair, and further the surface of the second input/output portion body 40 can be made approximately flush with the surface of the first input/output portion body 30 by the forward movement (pushing up) of the second input/output portion body 40 utilizing the second guide members 41, 42 (level difference can be eliminated), as shown in FIG. 4 and FIG. 12. Accordingly, an information terminal device can be realized in which the appearance is improved in both states, namely a housed (stacked) state and a drawn out (expanded) state.

Also, although the wristwatch type information terminal is small and compact, the amount of display and/or input operations is limited with only the area of the dial face portion 11, whereas by enlarging the area of the input/output portion by drawing out the second input/output portion 4, as appropriate, as in the information terminal device 1 according to the present embodiment, the functionality as the information terminal device can be improved, and the device is favorable.

Here, in the present embodiment, the pins 512, 522 of the connecting members 51, 52 for the first guide members 31, 32 on the forward side are longer than the pins 513, 523 on the opposite side and the like so as to protrude outward, and the pin holes 315, 325 formed in the free end portions of the first guide members 31, 32 are formed in an arc shape, and therefore the pins 513, 523 can be moved by a user operation. An elastically deformable projection or a projection that retracts when a release button is operated protrudes inside each of the pin holes 315, 325. Accordingly, the first input/output portion body 30 and the second input/output portion body 40 can be held in a state of extending straight, as shown in FIGS. 4 and 12, for example, and the second input/output portion body 40 can be held in a risen state, as shown in FIG. 5. In this way, the pin holes 315, 325 and the like can constitute an angle adjusting mechanism.

According to such a configuration, in a wristwatch type information terminal device, for example, the free end side of the second input/output portion 4 that has been drawn out upward faces upward, which improves visibility, or in an information terminal device used as a mobile phone, the free end portion side approaches an ear, and the base end portion side approaches a mouth, which makes talking easier. The angle adjusting mechanism may be configured by the free end portion side of the first guide members 31, 32 or the base end portion side of the second guide members 41, 42 being bent using a hinge or the like, instead of using the pin holes 315, 325 and the like. Also, the angle adjustment may be performed in an electrically driven manner using a screw, a rack belt, a worm gear, or the like, along with the sending out of the second guide members 41, 42 from between the first guide members 31, 33; 32, 34 and the pushing out of the second input/output portion body 40.

Also, if the displays in the first input/output portion 3 and the second input/output portion 4 are realized using an electronic paper or an organic EL film display, specifically using an organic EL film display with a resin substrate, because these elements are thin and flexible, the thickness of the information terminal device 1 in which the first input/output portion 3 and the second input/output portion 4 are stacked in a stored (housed) state can be reduced. Also, when the first input/output portion 3 and the second input/output portion 4 are configured to be angle adjustable, and are folded inward as shown in FIG. 5, as described above, these thin and flexible materials are favorable to form curved faces 302, 402 (so-called round form) on the free end side of the first input/output portion 3 and on the base end side of the second input/output portion 4 in order to eliminate interference therebetween.

### Second Embodiment

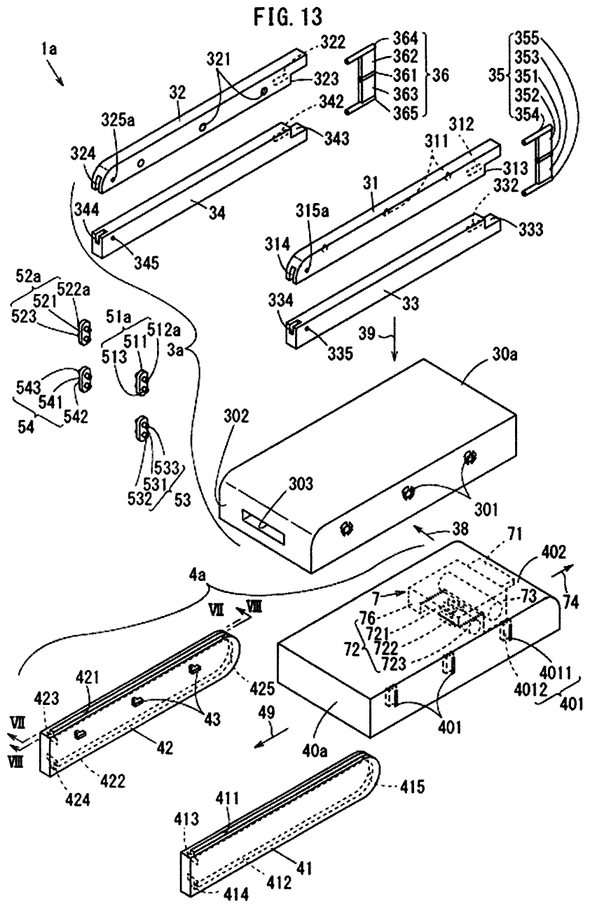

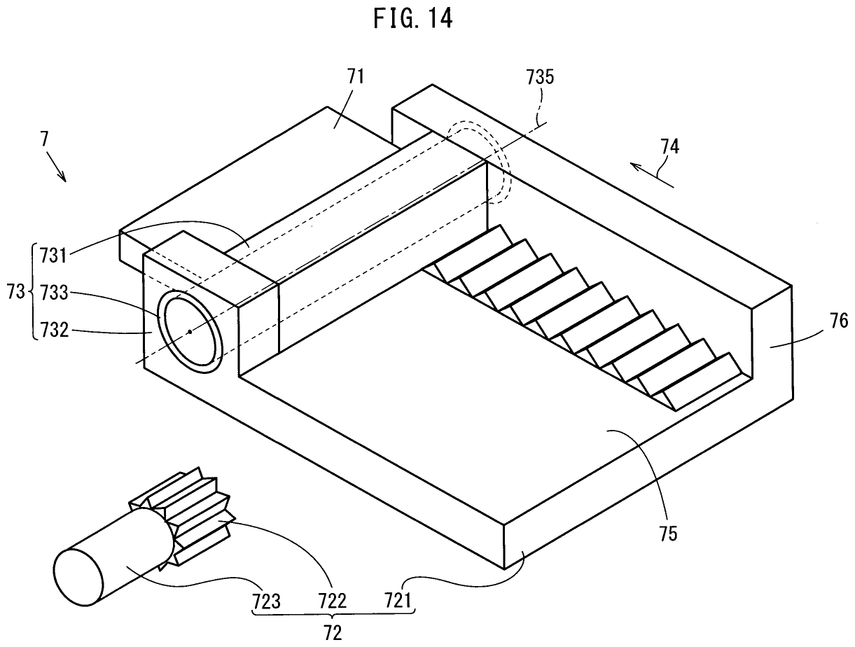

FIG. 13 is an exploded perspective view of a wristwatch type information terminal device 1a according to another embodiment of the present invention, and corresponds to FIG. 6. In the information terminal device 1a, the portions similar to and corresponding to those in the information terminal device 1 are given the same reference numerals, and the description thereof will be omitted. In the information terminal device 1 described above, the angle adjustment as shown in FIG. 5 is performed by moving the pins 512, 522 inside the arc-shaped pin holes 315, 325, and pulling up the second guide members 41, 42. In contrast, it should be noted that a mechanism 7 for angle adjustment is provided in the information terminal device 1a.

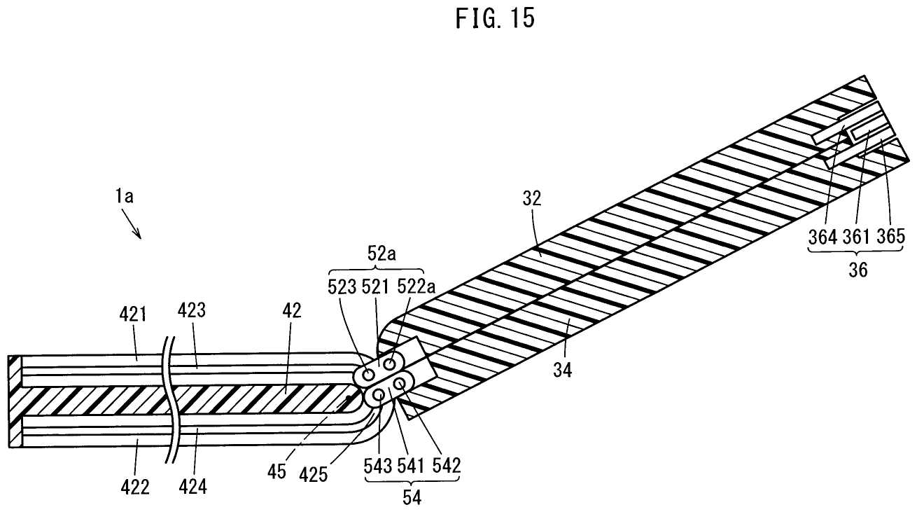

FIG. 14 is an exploded perspective view of the mechanism 7 for angle adjustment. This mechanism 7 is provided on a base end side of a second input/output portion body 40a. The mechanism 7 is configured to include a connecting piece 71 that, after a second input/output portion 4a is drawn out, advances to a free end side of a first input/output portion body 3a and is integrated therewith, a sending out mechanism 72 for advancing the connecting piece 71, and an angle adjusting mechanism 73 that is interposed between the sending out mechanism 72 and the connecting piece 71.

The sending out mechanism 72 is configured to include a main body 721 including a rack rail 75 that is a plate-shaped or band-shaped body that extends in a sending out direction 74 (direction opposite to the drawing out direction 49), and in which protrusions and recesses are formed at predetermined intervals in the sending out direction 74, a gear 722 that engages with the rack rail 75, and a motor 723 that drives the gear 722. In FIGS. 13 and 14, in the main body 721, a rib 76 for reinforcement and guiding is provided in a plate-shaped or band-shaped body.

The angle adjusting mechanism 73 is configured to include a rotating shaft 731 to which the base end side of the connecting piece 71 is fixed, a housing 732 attached to an end portion of the main body 721, and a lock mechanism 733 that is fitted between the housing 732 and the rotating shaft 731. The lock mechanism 733 can be realized by a detent mechanism that can hold the angle at predetermined angle intervals by engagement between recesses and protrusions, a friction mechanism that can hold the angle at any continuous angle, or the like.

In correspondence with the mechanism 7, a hole 303 in which the connecting piece 71 is fitted is formed on a free end side of the first input/output portion body 30a. Also, connecting members 51a, 52a are formed similarly to the connecting members 53, 54, and short pins 512a, 522a are formed. Also, circular pin holes 315a, 325a are formed. Accordingly, the pins 512a, 522a are pivotably supported inside the pin holes 315a, 325a without position shift.

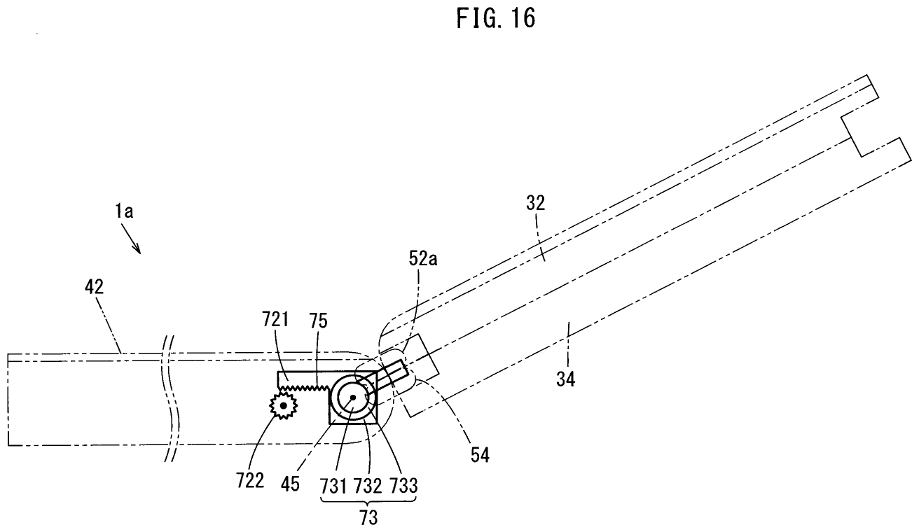

FIG. 15 is a cross-sectional view of the information terminal device 1a corresponding to FIG. 12, and FIG. 16 is a transparent side view corresponding to FIG. 15. In the present embodiment as well, in second guide members 41, 42, guide grooves 413, 414; 423, 424 in which pins 513, 533; 523, 543 slide extend in parallel from a sliding face on a free end side, and are connected by semi-arc-shaped portions 415, 425 at the base end side, as described above. Also, an axis 735 of the rotating shaft 731 of the angle adjusting mechanism 73 matches a center 45 of the arc-shaped portions 415, 425.

Therefore, as shown in FIG. 12, after drawing out the second input/output portion 4a, the connecting piece 71 is advanced by the sending out mechanism 72 in the sending out direction 74 and is inserted into the hole 303, and as a result, the second input/output portion body 40a and the first input/output portion body 30a are integrated, and furthermore, by rotating the lock mechanism 733 of the angle adjusting mechanism 73, the pins 513, 523; 533, 543 of the connecting members 51a, 52a; 53, 54 slide in the semi-arc-shaped portions 415, 425, and as a result, the first input/output portion 3a and the second input/output portion 4a can be connected at an angle, as shown in FIGS. 15 and 16.

Also, here, angle adjustment is performed by the angle adjustment mechanism 7 provided on the base end side of the second input/output portion body 40a, and therefore, angle adjustment can be accurately performed with less rattle than in the information terminal device 1 in which angle adjustment is performed using the connecting members 51, 52. Moreover, the pins 513, 523; 533, 543 can pass through the arc-shaped portions 415, 425 and enter guide grooves on the opposite side, which makes angle adjustment smooth and also contributes to keeping the adjusted (folded) state.

Furthermore, drawing out of the connecting piece 71, which is difficult to draw out from the outside of the second input/output portion 40a, can be performed in an electrically driven manner using the motor 723, the gear 722, and the rack rail 75.

### Third Embodiment

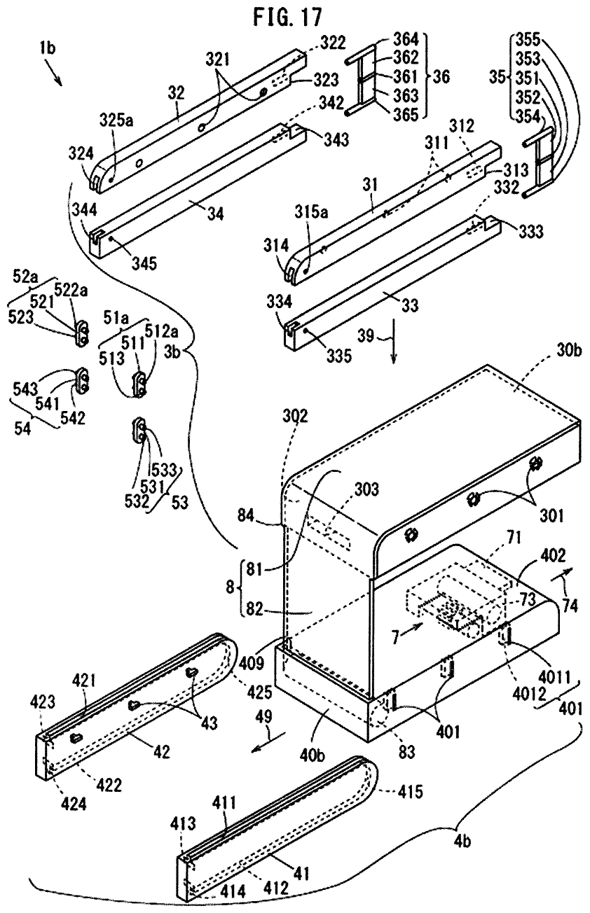

FIG. 17 is an exploded perspective view of a wristwatch type information terminal device 1b according to yet another embodiment of the present invention, and corresponds to FIGS. 6 and 13. In the information terminal device 1b, the portions similar to and corresponding to those in the information terminal devices 1, 1a described above are given the same reference numerals, and the description thereof will be omitted. The information terminal device 1b is configured by further adding features to the information terminal device 1a. In the information terminal devices 1, 1a described above, the first input/output portions 3, 3a and the second input/output portions 4, 4a are separate bodies, that is, the devices are constituted by two divided screens, from the viewpoint of image display. In contrast, it should noted that the information terminal device 1b of the present embodiment is constituted by one continuous screen.

Therefore, an input/output portion 8 that can perform display and/or input operations as an information terminal device is formed as a film in a band shape. Also, a first input/output portion 3b is configured by a substantially half face 81 thereof being attached to a first input/output portion body 30b. The remaining substantially half face 82 is drawn out from a free end side of the first input/output portion body 30b, is drawn inside the second input/output portion body 40b through a slit 409 formed on a free end side of a second input/output portion 40b, is wound as indicated by reference numeral 83, and as a result, a second input/output portion 4b is configured. Therefore, the portion of the remaining substantially half face 82 that is actually drawn inside the second input/output portion body 40b through the slit 409 has a smaller width than the substantially half face 81 due to notches 84.

Accordingly, in a stacked state of the first input/output portion 3b and the second input/output portion 4b, as shown in FIG. 1, the portion of the remaining substantially half face 82 other than the portion along a curved face 302 is wound and housed inside the second input/output portion body 40b, and as a result of the second input/output portion 4b being drawn out through the slit 49, as shown in FIGS. 2 to 4, and expanded on the second input/output portion body 40b, the continuous screen is formed. Here, just a portion of the substantially half face 81 on the base end side of the first input/output portion 3b may be attached to the first input/output portion body 30b, but the entire face thereof may be attached. According to this configuration, when the first input/output portion 3b and the second input/output portion 4b are folded inward, as shown in FIG. 5, the input/output portion 8 formed as a film will not rise up, is in close contact with the surfaces, and will not interfere with touch operations or the like, and this configuration is favorable.

According to such a configuration, the second input/output portion 4b can be formed continuously with the first input/output portion 3b without any discontinuity, and the design can be improved.

The information terminal device according to the present invention is an information terminal device in which, by drawing out a second input/output portion from a rear side of a first input/output portion that is able to perform display and/or input operations as an information terminal device, the area of these input/output portions is enlargeable, wherein the first input/output portion includes: a plate-shaped first input/output portion body; front and back pairs of first guide members that extend in a drawing out direction, the first guide members in each pair being provided on respective sides of the first input/output portion body in a view from the front; folding members that are provided on a base end side in the drawing out direction so as to increase/decrease the distance between the front and back pairs of first guide members, the second input/output portion includes: a plate-shaped second input/output portion body that is able to be hidden on the rear side of the first input/output portion body; and a pair of second guide members that extend in the drawing out direction and are provided on respective sides of the second input/output portion body, the second guide members enabling the second input/output portion body to be drawn out by sliding between the front and back pairs of first guide members, and supporting the second input/output portion body so as to be movable forward in a drawn-out state, and the information terminal device further including: connecting members that are provided on a free end side of the first guide members, hold sliding faces of the second guide members and the first guide members when the second guide members are drawn out from between the first guide members, and are able to come around to a base end side of the second guide members in a drawn out completion state.

According to the configuration described above, in a mobile information terminal device such as a wristwatch type information terminal, a game machine, a tablet terminal, or a personal computer, or here in the case of a wristwatch type information terminal for example, a predetermined function can be fulfilled with the size of a normal dial face for displaying the time. However, it is difficult to realize the display and/or input operations sufficiently with only the area of the dial face, as the information terminal device, and heretofore the functions that can be realized were limited. Therefore, according to the present invention, the area of the input/output portion can be enlarged by drawing out the second input/output portion from the rear side of the first input/output portion.

Also, in order to store (fold) and draw out (expand) the second input/output portion, the first input/output portion is provided with the pairs of first guide members that extend in the drawing out direction respectively on both sides of the plate-shaped first input/output portion body, as a pair that is a front and back pair viewed from the front (a top and bottom viewed from the side face, for example), and also provided with the folding members that each connect the front and back (top and bottom) pair of first guide members, on the base end side of the front and back (top and bottom) pair of first guide members in the drawing out direction such that the distance between the pair can be increased and decreased.

Meanwhile, the second input/output portion is provided with the second guide members respectively on both sides of the plate-shaped second input/output portion body that can be hidden on the rear side of the first input/output portion body, the second guide members extending in the drawing out direction as a pair. The second guide members enable the drawing out of the second input/output portion body by each sliding while being sandwiched between the front and back (top and bottom) pair of first guide members, and support the second input/output portion body so as to be moved (pushed up) forward (upward) in a state of being drawn out.

Also, the first guide members and the second guide members are connected by the connecting members provided on the free end side of the front and back (top and bottom) pairs of first guide members, which are also left and right pairs. The connecting members hold the second guide members when each being drawn out between the front and back (top and bottom) pair of first guide members such that the front and back (top and bottom) faces of the second guide members slide on the back and front (bottom and top) faces of the first guide members, and are configured to come around to the base end side of the second guide members when the drawing out is completed.

Therefore, in a mobile information terminal device, the first input/output portion and the second input/output portion can be used in combination by drawing out (expanding) the second input/output portion, as needed, from a state in which these portions are stacked and only the first input/output portion body can be used, and as a result, the area of the input/output portion is increased and high-level functionality can be realized. Also, the second input/output portion is drawn out further from the free end of the first input/output portion by sliding between the first guide members and the second guide members, in which the connecting members are utilized, and the first input/output portion body and the second input/output portion body are arranged side by side, and thereafter, as a result of the connecting members coming around to the base end side of the second guide members and the folding member folding, the front and back (top and bottom) pairs of first guide members each enter a stacked state in which the side faces are continuous, and furthermore, as a result of the second input/output portion body moving forward (upward) (pushing up) by the second guide members, the surface of the second input/output portion body can be made approximately flush with the surface of the first input/output portion body (level difference can be eliminated). Accordingly, an information terminal device whose appearance is improved across a housed (stacked) state to a drawn out (expanded) state can be realized.

Also, in the information terminal device according to the present invention, the connecting members are each provided with pins for swingably and pivotably supporting a plate or rod-shaped body in the vicinity of two end portions of the plate or rod-shaped body, the first guide members are each provided with a slit, for making the plate or rod-shaped body swingable, in a free end side end face from a sliding face side, and one of the pins is pivotably supported inside the slit, and the second guide members are each provided with a slit that extends from a sliding face on the free end side to a base end side end face and into which the plate or rod-shaped body is loosely inserted, and each include a guide groove, for the pin, whose width is increased inside the second guide member in communication with the slit.

According to such a configuration, the connecting members that guide drawing out of the second guide members from between the first guide members are each configured by a plate or rod-shaped body, and pins, for swingably and pivotably support the plate or rod-shaped body, that are provided near the two end portions of the plate or rod-shaped body. Meanwhile, slits are formed in the first guide members, the slits extending from the sliding face side to the free end side end face and enabling the plate or rod-shaped body to swing, and one of the pins is pivotably supported inside of the slit. Also, slits in each of which the plate or rod-shaped body is loosely inserted are formed in the second guide members, the slits each extending from the sliding face on the free end side to the base end side end face, and guide grooves, for the pins, whose width is increased are formed inside the respective slits in communication therewith.

Therefore, the plate or rod-shaped bodies of the connecting members are upright in the stacking direction of the first input/output portion and the second input/output portion while the second guide members are drawn out, and guide the drawing out, and incline in accordance with the drawing out of the second guide members from the state immediately before completion of the drawing out, and as a result, in each front and back (top and bottom) pair of first guide members, the distance between the free end sides of the pairs of first guide members is decreased and the first guide members are in close contact in the drawn out completion state, and the first guide members can be arranged approximately flush with the corresponding second guide member side by side. Meanwhile, the distance between the first guide members on the base end side can be decreased by the folding members. Accordingly, the front and back (top and bottom) pairs of first guide members can each enter a stacked state, and the first guide members and the second guide member can be arranged side by side.

Furthermore, in the information terminal device according to the present invention, an angle adjusting mechanism is provided on a free end side of the first guide members.

According to the configuration described above, the second guide members in a state of being drawn out and the first guide members do not extend on straight lines, and instead are connected at an angle by the angle adjusting mechanism.

Therefore, in a wristwatch type information terminal device, for example, the free end side of the second input/output portion that has been drawn out upward faces upward, and the visibility is improved, or in an information terminal device used as a mobile phone, the free end portion side approaches an ear, and the base end portion side approaches a mouth, and talking is made easier.

Also, the information terminal device according to the present invention further includes: on a base end side of the second input/output portion body, a connecting piece that advances to a free end side of the first input/output portion body and is integrated with the first input/output portion body after the second input/output portion is drawn out; a sending out mechanism configured to cause the connecting piece to advance; and an angle adjusting mechanism interposed between the sending out mechanism and the connecting piece.

According to the configuration described above, the second guide members in a state of being drawn out and the first guide members can be connected at an angle by the angle adjusting mechanism, in addition to extending on straight lines. Therefore, in a wristwatch type information terminal device, for example, the free end side of the second input/output portion that has been drawn out upward faces upward, and the visibility is improved, or in an information terminal device used as a mobile phone, the free end portion side approaches an ear, and the base end portion side approaches a mouth, and talking is made easier.

Also, here, the angle adjustment is performed by the angle adjusting mechanism provided on the base end side of the second input/output portion body. Therefore, after the second input/output portion is drawn out, the connecting piece is advanced from the base end side of the second input/output portion body to the free end side of the first input/output portion body and is integrated therewith, and the advancement is performed by the sending out mechanism. Meanwhile, the angle adjusting mechanism is interposed between the sending out mechanism and the connecting piece. Accordingly, as a result of performing the angle adjustment by the angle adjusting mechanism instead of using the connecting members, the angle adjustment can be accurately performed with little rattle.

Furthermore, in the information terminal device according to the present invention, the guide grooves for the pins in the second guide members are each configured to include parallel portions that extend from a sliding face on the free end side in parallel, and an arc-shaped portion in a semicircular arc shape that connects, on the base end side, the parallel portions on the front and back, and the rotating axis of the angle adjusting mechanism matches the center of the arc-shaped portion.

According to the configuration described above, in order to perform the angle adjustment by the angle adjusting mechanism provided in the second input/output portion body, the front and back of the guide grooves for pins in each second guide member for guiding the connecting members are connected by a semicircular arc-shaped arc-shaped portion, and the rotating axis of the angle adjusting mechanism matches the center of the arc-shaped portion.

Therefore, each pin can pass through the arc-shaped portion and advances into the guide groove on the opposite side, and therefore the angle adjustment can be smoothly performed, and this configuration can contribute to holding the adjusted (bent) state.

Also, in the information terminal device according to the present invention, the sending out mechanism is configured to include: a main body including a rack rail that is a plate or band-shaped body that extends in a sending out direction, and in which recesses and protrusions are formed at predetermined intervals; a gear that engages with the rack rail; and a motor that drives the gear.

According to the configuration described above, the drawing out of the connecting piece that is difficult to draw out from the outside of the second input/output portion can be performed in an electrically driven manner.

Furthermore, in the information terminal device according to the present invention, the first input/output portion has a front face having attached thereto a substantially half face of a band-shaped input/output portion made as a film that is able to perform display and/or input operations as the information terminal device, and the remaining substantially half face of the band-shaped input/output portion made as a film is drawn out from a free end side of the first input/output portion body, and is drawn inside the second input/output portion body through a slit formed on a free end side of the second input/output portion, and in a stacked state of the first input/output portion and the second input/output portion, is wound and housed inside the second input/output portion body.

According to the configuration described above, the portion where actual input and output are performed is formed by film, and the film is formed in a band shape. The first input/output portion is constituted by a substantially half face of the band being attached to the first input/output portion body, and the remaining substantially half face extends from the free end side of the first input/output portion body and is wound inside the second input/output portion body, and as the second input/output portion is drawn out from the first input/output portion, the remaining substantially half face is drawn out through a slit formed on the free end side of the second input/output portion body.

Therefore, the second input/output portion can be formed continuously from the first input/output portion without a break, and the design can be improved.

Also, in the information terminal device according to the present invention, a locking claw is formed on either the first guide members on the forward side or the first input/output portion body, and a locking recession is formed in the other, and fixing thereof is achieved by the locking claw and the locking recession fitting together.

According to the configuration described above, one of locking claws and locking recessions are formed in the first guide members on the forward (upward) side of the front and back (top and bottom) pairs of first guide members, and the other of the locking claws and locking recessions are formed in the first input/output portion body, and the first guide members are fixed to the first input/output portion body by fitting, that is, so-called snap-fitting between the locking claws and locking recessions. Therefore, assembling of the first input/output portion is facilitated.

Furthermore, in the information terminal device according to the present invention, the display in the first input/output portion and the second input/output portion is realized by an electronic paper.

According to the configuration described above, the electronic paper is thin and flexible. Therefore, this configuration contributes to reducing the thickness of an information terminal device in which the first input/output portion and the second input/output portion are stacked in a stored (housed) state. Also, the electronic paper, which is thin and flexible, is favorable when the free end side of the first input/output portion and the base end side of the second input/output portion are formed into curved faces in order to eliminate interference therebetween when the first input/output portion and the second input/output portion are configured to be able to adjust the angle therebetween and these portions are bent inward.

Also, in the information terminal device according to the present invention, the display in the first input/output portion and the second input/output portion is realized by an organic EL film display with a resin substrate.

According to the configuration described above, an organic EL film display, above all, an organic EL film display with a resin substrate is thin and flexible. Therefore, this configuration contributes to reducing the thickness of an information terminal device in which the first input/output portion and the second input/output portion are stacked in a stored (housed) state. Also, the organic EL film display, which is thin and flexible, is favorable when the free end side of the first input/output portion and the base end side of the second input/output portion are formed into curved faces in order to eliminate interference therebetween when the first input/output portion and the second input/output portion are configured to be able to adjust the angle therebetween and these portions are bent inward.

Furthermore, in the information terminal device according to the present invention, the information terminal device is a wristwatch type information terminal.

According to the configuration described above, although the wristwatch type information terminal is small and not cumbersome, the amount of display and/or input operations is limited with only the area of a dial face portion, in contrast, by enlarging the area of the input/output portion by drawing out the second input/output portion, as appropriate, as in the information terminal device according to the present invention, the functionality as the information terminal device can be improved.

### INDUSTRIAL APPLICABILITY

The information terminal device according to the present invention is configured to be compact by enlarging the area of an input/output portion by drawing out a second input/output portion from the rear side of a first input/output portion, in a wristwatch type information terminal device, for example, and also the first input/output portion is configured to include a plate-shaped first input/output portion body, first guide members that are provided on both sides of the first input/output portion body, as a pair, and are also provided as a front and back (top and bottom) pair, and folding members that are provided on base end side of the first guide members so as to increase/decrease the distance between the front and back pair, in order to realize high-level functionality and/or multi-functionality, and the second input/output portion is configured to include a plate-shaped second input/output portion body, and second guide members that are respectively provided on both sides of the second input/output portion body, as a pair, the second input/output portion can be drawn out by the second guide members sliding while being sandwiched between the first guide members via connecting members, the second guide members move the second input/output portion forward in a drawn out state so as to be flush with the first input/output portion, and the distance between the first guide members is decreased by folding the folding members. Therefore, the appearance of the information terminal device can be improved, and this configuration is favorable.

1. An information terminal device, comprising:
a first input and output portion, rising:
a plate-shaped as a first input and output portion body;
front and back pairs of first guide members that extend in a drawing out direction, the first guide members in each pair being provided on respective sides of the first input/output portion body in a view from the front;
folding members that are provided on a base end side in the drawing out direction so as to change a distance between the front and back pairs of first guide members;
a second input and output portion, comprising:
a plate-shaped as a second input and output portion body that is able to be hidden on a rear side of the first input and output portion body; and
a pair of second guide members that extend in the drawing out direction and are provided on respective sides of the second input and output portion body, the second guide members enabling the second input and output portion body to be drawn out by sliding between the front and back pairs of first guide members, and supporting the second input and output portion body so as to be movable forward in a drawn-out state, and
connecting members that are provided on a free end side of the first guide members, hold sliding faces of the second guide members and the first guide members when the second guide members are drawn out from between the first guide members, and are able to come around to a base end side of the second guide members in a drawn out completion state, wherein at least one of display operations, input operations, and output operations can be performed through an area of the first input and output portions and wherein the area is enlargeable by drawing out the second input and output portion from the rear side of the first input and output portion.

2. The information terminal device according to claim 1,
wherein the connecting members are each provided with pins for swingably and pivotably supporting body that is shaped as one of a rod and a plate (“plate or rod shaped body”) in a vicinity of two end portions of the plate or rod-shaped body,
the first guide members are each provided with a slit, for making the plate or rod-shaped body swingable, in end face of the free end side end face from a sliding face side, and one of the pins is pivotably supported inside the slit, and
the second guide members are each provided with a slit that extends from a sliding face on the free end side to an end face of the base end side and into which the plate or rod-shaped body is loosely inserted, and each comprise a guide groove, for the pin, whose width is increased inside the second guide member in communication with the slit.

3. The information terminal device according to claim 2, wherein an angle adjusting mechanism is provided on a free end side of the first guide members.

4. The information terminal device according to claim 2, further comprising:
a connecting piece on a base end side of the second input and output portion body that advances to a free end side of the first input and output portion body and is integrated with the first input and output portion body after the second input and output portion is drawn out;
a sending out mechanism configured to cause the connecting piece to advance; and
an angle adjusting mechanism interposed between the sending out mechanism and the connecting piece.

5. The information terminal device according to claim 4, wherein the guide grooves for the pins in the second guide members each comprise parallel portions that extend from a sliding face on the free end side in parallel, and an arc-shaped portion in a semicircular arc shape that connects, on the base end side, the parallel portions on the front and back, and a rotating axis of the angle adjusting mechanism matches the center of the arc-shaped portion.

6. The information terminal device according to claim 5, wherein the sending out mechanism further comprises:
a main body comprising a rack rail that is a plate or band-shaped body that extends in a sending out direction, and in which recesses and protrusions are formed at predetermined intervals;
a gear that engages with the rack rail; and
a motor that drives the gear.

7. The information terminal device according to any one of claim 1,
wherein the first input and output portion has a front face having attached thereto a substantially half face of a band-shaped film through which the display operations, input operations, and output operations can be performed, and
wherein the remaining substantially half face of the band-shaped film is drawn out from a free end side of the first input and output portion body, and is drawn inside the second input and output portion body through a slit formed on a free end side of the second input and output portion, and in a stacked state of the first input and output portion and the second input and output portion, is wound and housed inside the second input and output portion body.

8. The information terminal device according to claim 1, further comprising:
a locking claw is formed on one of a forward side of one of the first guide members or the first input and output portion body; and
a locking recession is formed in the one the forward side of the one of the first guide members or the first input and output portion body, wherein a fixing of the one first guide member and the input portion body is achieved by the locking claw and the locking recession fitting together.

9. The information terminal device according to claim 1, wherein the first input and output portion and the second input and output portion comprise electronic paper used for the display operations.

10. The information terminal device according to any one of claim 1, wherein the first input and output portion and the second input and output portion comprise an organic EL film display with a resin substrate used for the display operations.

11. The information terminal device according to claim 1, further comprising a wristwatch type information terminal that comprises the first input and output portion, the second input and output portion, and the connecting members.

12. The information terminal device according to claim 11, wherein when the second input and output portion is drawn out, a free end side of the second input and output portion faces upward.

13. The information terminal device according to claim 11, wherein the wristwatch further comprises a biosensor and physiological data measured by the biosensor is displayed via one or more of the display operations.

14. The information terminal device according to claim 1, further comprising a mobile phone that comprises the first input and output portion, the second input and output portion, and the connecting members.

15. The information terminal device according to claim 14, wherein when the second input and output portion is drawn out, a free end side of the second input and output portion is proximate to an ear of the mobile phone.

16. The information terminal device according to claim 9, wherein the electronic paper is flexible and wherein a free end side of the first input and output portion and a base end side of the second input and output surfaces form curved surfaces.

17. The information terminal device according to claim 10, wherein the organic EL film display is flexible and wherein a free end side of the first input and output portion and a base end side of the second input and output surfaces form curved surfaces.

18. The information terminal device according to claim 1, further comprising a touch panel stacked upon the first input and output portion body.

19. The information terminal device according to claim 1, wherein an information processing circuit, a circuit for communicating with external devices, and a battery are comprised within the first input and output portion body.

20. The information terminal device according to claim 1, further comprising a game machine that comprises the first input and output portion, the second input and output portion, and the connecting members.
